(19) United States
(12) Patent Application Publication
(10) Pub. No.: US 2006/0029755 A1
(43) Pub. Date: Feb. 9, 2006

(54) Alternative moisture and temperature resistant forming tubes

(76) Inventors: Peter T. Tkacik, Fort Mill, SC (US); David A. Partin, Kernersville, NC (US); Joel G. Sweatman, Kernersville, NC (US); Jimmy A. Russell, Rock Hill, SC (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/195,138

(22) Filed: Aug. 2, 2005

Related U.S. Application Data
(60) Provisional application No. 60/598,317, filed on Aug. 3, 2004.
(60) Provisional application No. 60/659,530, filed on Mar. 8, 2005.
(60) Provisional application No. 60/695,566, filed on Jun. 30, 2005.

(51) Int. Cl. B32B 27/10; B29C 33/50

(52) U.S. Cl. 428/34.2; 264/166; 264/313

(57) ABSTRACT

The invention is a collapsible tube having excellent moisture and temperature-resistance. The collapsible tube, such as a spirally wound or convolute paperboard forming tube, includes moisture-resistant and temperature-resistant layers at its inside and outside surfaces. These moisture-resistant and temperature-resistant layers may be polymeric, parchment, or metallic materials, particularly metal foil layers. The collapsible tube is especially useful as a reusable forming tube in the manufacture of glass fibers.

### BACKGROUND OF THE INVENTION

This application hereby claims the benefit of the following commonly-assigned provisional patent applications: U.S. Provisional Patent Application Ser. No. 60/598,317, for Moisture and Temperature Resistant Forming Tubes, filed Aug. 3, 2004; U.S. Provisional Patent Application Ser. No. 60/659,530, for Alternative Moisture and Temperature Resistant Forming Tubes, filed Mar. 8, 2005; and U.S. Provisional Patent Application Ser. No. 60/695,566, for Alternative Moisture and Temperature Resistant Forming Tubes, filed Jun. 30, 2005. This application incorporates entirely by reference these provisional applications.

The present invention relates to forming tubes that are especially useful in processes for forming glass fiber.

In this regard, the process of making glass fiber involves the winding of a hot glass fiber around a fast-rotating forming tube. After winding to form a fiberglass spool, the glass fiber is further processed at elevated temperatures. Then, the forming tube is partially collapsed and extracted from the interior of the fiberglass spool. Thereafter, the glass fiber can be rewound onto bobbins or formed directly into fabric.

Those having ordinary skill in the art will recognize that the manufacture of glass fiber demands that forming tubes not only have acceptable wet strength, but also be capable of enduring centrifugal forces and processing temperatures.

Forming tubes are typically helically wound tubes of three or more kraft paper plies in which each ply includes a spiral butt joint. Those having ordinary skill in the art will understand that a spiral butt joint describes a configuration in which strips of paper are wound edge to edge. The spiral butt joints in contiguous layers are typically staggered to enhance strength.

Paperboard forming tubes, like those disclosed by U.S. Pat. Nos. 3,165,034 and Re 23,899, are made by helically winding separate plies of paper around a stationary mandrel. These forming tubes are sometimes treated with a silicone release agent to permit the tubes to be more easily removed from the interior of a fiberglass spool.

A forming tube, when used in forming glass fiber, is often positioned on a collet drive and rotated about the axis of the tube. The tube is brought up to speed (e.g., 3,000-4,000 RPM) before winding of the glass fiber begins. Problems occur, however, in the formation of glass fiber using devices that operate at higher speeds (e.g., 7,000 RPM). Existing paperboard forming tubes have been unusable at high speeds because increased centrifugal forces cause them to rupture. In short, high rotational speeds require stronger forming tubes.

Existing forming tubes may be bendable to facilitate removal from fiberglass spools, but have not been sufficiently flexible or sufficiently durable to reuse. As a result, the forming tubes could be used safely but once before being discarded. Forming tubes designed to overcome this problem are often so expensive that it is more cost effective to employ single-use forming tubes than known reusable forming tubes.

Paperboard tubes are used in other applications. For example, rigid, helically wound textile tubes are disclosed by U.S. Pat. No. 2,751,936. This patent discloses three inner plies of spiral butt joints and one outer ply with a spiral overlapped joint.

Paperboard tubes are also known to provide spiral-overlapped joints on both the inner and outer plies for other purposes. For example, paperboard tubes are used for mailing tubes (e.g., U.S. Pat. No. 726,894) and food containers (e.g., U.S. Pat. No. 3,183,802).

U.S. Pat. No. 2,181,035, which relates to tubing for insulating electrical conductors, discloses spiral overlapped joints for intermediate and outer plies and spiral butt joints for inner plies. This patent discloses that the tube has increased tensile strength with sufficient flexibility to be bent or twisted without objectionable injury to achieve the desired accordion flexure of the plies. These characteristics are apparently achieved by providing at least one layer of a cellophane-like material having overlapped spiral joints and one or more layers of kraft paper, together with one or more layers of crepe paper, which also may have overlapped spiral joints. This disclosed tube, however, is not used under the severe conditions required for fiberglass manufacture (i.e., sprayed with an aqueous solution and heated to high temperatures for extended periods).

Therefore, there is a need for a cost-effective, reusable forming tube having excellent moisture and temperature resistance.

### SUMMARY OF THE INVENTION

Accordingly, it is an object of the present invention to provide a cost-effective forming tube for use and reuse in the manufacture of glass fibers.

It is a further object of the present invention to provide a paperboard forming tube having outstanding moisture resistance.

It is a further object of the present invention to provide a paperboard forming tube having excellent temperature resistance.

It is a further object of the present invention to provide a moisture-resistant and temperature-resistant tube that is collapsible but that can recover its original shape.

It is a further object of the present invention to provide methods for using and reusing such forming tubes in the manufacture of fiberglass filaments.

It is a further object of the present invention to provide methods for making such forming tubes.

The foregoing, as well as other objectives and advantages of the invention and the manner in which the same are accomplished, is further specified within the following detailed description and its accompanying drawings.

### BRIEF DESCRIPTION OF THE DRAWINGS

FIG. 1 is a schematic view showing the formation and winding of glass fiber;

FIG. 2 represents a block diagram of the main steps in the process of forming glass fiber; and

FIG. 3 shows a perspective view of a forming tube of the present invention.

### DETAILED DESCRIPTION

In one aspect, the invention is a collapsible tube having excellent moisture and temperature resistance.

As set forth herein, the collapsible tube preferably includes a fibrous structure, such as a spirally wound or convolute paperboard structure. The collapsible tube further includes moisture-resistant and temperature-resistant layers at its inside surface and outside surface. As set forth herein, these moisture-resistant and temperature-resistant layers typically include polymeric, parchment, or metallic materials, and are preferably metal foil layers. Although the collapsible tube is typically a substantially cylindrical structure, it can be made in other shapes, too.

In another aspect, the invention is a method of making such forming tubes.

In yet another aspect, the invention is a method of using such forming tubes in the manufacture of glass filaments.

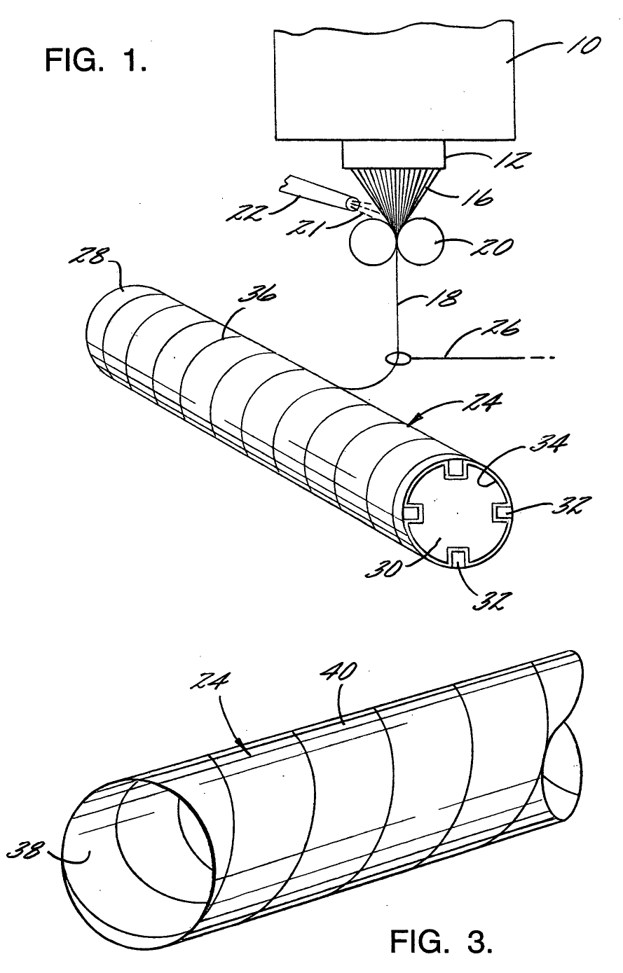

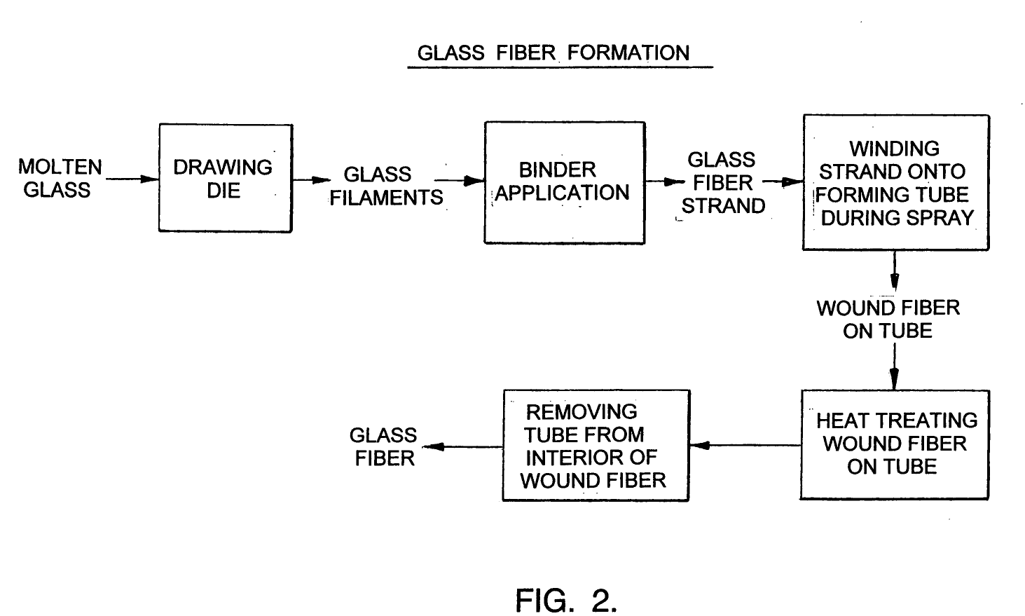

An appreciation of the present invention may be achieved by reviewing typical methods for manufacturing fiberglass. With reference to FIGS. 1 and 2, the equipment necessary for forming glass fiber includes a furnace 10 for melting and supplying molten glass to a drawing die 12. The drawing die 12 includes numerous holes therein for producing a corresponding number of fine filaments 16. These filaments 16 are then formed into a single strand 18 by rollers 20 while an aqueous binder 21, or sizing, is applied to the filaments via a sprayer 22. As is known to those having ordinary skill in the art, the binder 21 is necessary to adhere the fine filaments 16 together into a strand 18. The binder 21 also helps the glass fiber to adhere to rubber or to take on stains or colors.

During binder or sizing application, the forming tube 24 is necessarily subjected to the aqueous binder 21, both from the solution that adheres to the strand 18 and from the binder 21 that is oversprayed onto the forming tube 24 from the sprayer 22.

The glass fiber strand 18 is controlled by a traveler 26 so that the strand 18 can be wound around the outer surface 28 of the forming tube 24 with approximately equal distribution. The forming tube 24 is rotated by any suitable rotary drive mechanism. One such device is a collet drive 30 as depicted in FIG. 1.

The collet drive 30 includes centrifugally actuated fingers 32 that are spaced about its periphery. As the collet drive 30 is rotated, the centrifugal force acting upon the fingers 32 causes them to engage the inner surface 34 of the forming tube 24. In effect, the collet drive 30 is an expandable mandrel, thereby allowing the forming tube 24 to be placed on and removed from the drive 22 without additional measures.

The collet drive 30 typically rotates from about 3,000 RPM to 10,000 RPM. Moreover, the collet drive accelerates quickly, thereby subjecting the forming tube 24 to severe stresses. For example, a typical collet drive in the fiber industry may have a diameter of approximately 12 inches and a length of about four feet, and may accelerate from rest to 6,000 RPM in about nine seconds. Accordingly, those having ordinary skill in the art will recognize that the forming tube 24 must possess excellent strength characteristics to tolerate this kind of acceleration.

After about one hour of continuous rotation, a sufficient quantity of glass fiber 36 is wound in a generally circular fashion about the outer periphery of the forming tube 24, thereby forming a fiberglass spool. At this point, the collet drive 30 is stopped, which in turn allows the fingers 32 to resume their rest condition on the collet drive 30. Accordingly, those having ordinary skill the art will recognize that the forming tube 24 must be durable if it is to be reused.

The forming tube 24 and the glass fiber 36 wrapped around its periphery are then removed as a fiberglass spool. The fiberglass spool is placed into an oven for about 25 to 40 hours in order to dry the aqueous binder 21, which was previously sprayed onto the fiber strand 18. Drying is preferably conducted at temperatures between about 200 and 400° F., more preferably between about 225 and 375° F. (e.g., about 250° F.).

After oven drying, the forming tube 24 is collapsed (i.e., deformed) and removed from the interior of the fiberglass spool. The forming tube 24 is then preferably re-formed and the procedure begins again to form another fiberglass spool.

Thus, those having ordinary skill in the art will recognize that that the forming tubes of the present invention must possess certain characteristics. In this regard, the forming tubes must be flexible, yet strong enough to withstand the extreme centrifugal forces. The forming tubes must also have excellent wet strength and heat resistance up to 300° F., preferably up to 400° F. The forming tubes should also be sufficiently durable to permit repeated use.

As noted, in one aspect the invention is a collapsible tube having excellent moisture and temperature resistance.

In one embodiment, the collapsible tube is a substantially cylindrical structure having a first moisture-resistant and temperature-resistant layer (i.e., an inner protective layer) positioned on the tube's inside surface and a second moisture-resistant and temperature-resistant layer (i.e., an outer protective layer) positioned on the tube's outside surface.

The substantially cylindrical structure is preferably a fibrous structure, and more preferably a paperboard structure. In one embodiment, the paperboard structure includes one or more spirally wound paperboard plies. In another embodiment, the paperboard structure is a convolute tube.

As described previously, the moisture and temperature-resistant layers are metallic layers, parchment paper layers, polymeric layers, or combinations thereof. Metallic layers can include metallic foil, metallic spray, or metallic deposition materials, as well as combinations thereof. Metal foil layers are preferred. These may be discrete metallic foil layers or metal-paperboard laminates. Suitable metal foils include aluminum foil, tin foil, stainless steel foil, and titanium foil.

Polymeric layers can include, for example, moisture and temperature resistant sheets, films, and coatings. Suitable polymers include, without limitation, polyolefins (e.g., polyethylene), polyamides (e.g., nylon), fluoropolymers (e.g., polytetrafluoroethylene—PTFE, polyvinyl fluoride—PVF, or polyvinylidene difluoride—PVDF), and combinations thereof.

Alternatively, the moisture and temperature-resistant layers may include parchment paper, which is made from cellulose—a naturally occurring polymer. As will be understood by those having ordinary skill in the art, parchment paper is achieved by treating linear cellulose polymer chains with sulfuric acid. This acid treatment promotes cross-linking, thereby providing the parchment paper with improved wet strength and water resistance. In addition, some parchment paper (e.g., silicone-coated parchment paper) includes surface treatment to further enhance its durability.

As used herein, the terms “polymer” and “polymeric” are used in the conventional sense to refer to synthetic polymers (e.g., polyolefins, polyamides, or fluoropolymers) rather than to naturally occurring polymers (e.g., such as cellulose). Stated otherwise, the terms “polymer” and “polymeric” are not intended to embrace paper unless combined with the descriptor “naturally occurring” or the like (e.g., “naturally occurring polymers”).

The moisture and temperature-resistant layers may be positioned upon the tube's inside surface and outside surface via different processes. Such layers, for example, may be spirally wound, may be laminated to a pre-formed tube structure, may be part of a convolute tube structure, may be sprayed onto a pre-formed tube, or may be deposited via a vapor deposition technique. When spirally wound, the layers may include butt joints, overlap joints, and seam gap joints.

It will be recognized by those having ordinary skill in the art that the moisture-resistant and temperature-resistant layers should be able to resist the moisture levels and temperature levels present during the manufacture of glass fibers. Accordingly, exemplary moisture-resistant and temperature resistant layers are able to withstand temperatures greater than 300° F., more preferably greater than 400° F.

It will be further recognized that conventional moisture-resistant layers, such as wax and sizing layers are unlikely to meet the criteria of high-temperature resistance, even though they are recognized by those having ordinary skill in the art as having moisture-resistant properties.

The collapsible tube may also include at least one adhesive layer between the first and second moisture-resistant and temperature-resistant layers. Adhesives should be water-resistant and heat-resistant, yet flexible. An acceptable adhesive is tackified polyvinyl alcohol, such as that disclosed in U.S. Pat. No. 3,135,648. Water-based adhesives can be treated to make them thermosetting and water resistant (e.g., formaldehyde-treated dextrin and silicates).

The collapsible tube may also include at least one internal polymer layer, which can improve flexibility and enhance moisture and heat resistance. If present, polymer layers are preferably situated between the first and second moisture-resistant and temperature-resistant layers. Suitable polymers include, without limitation, polyolefins (e.g., polyethylene), polyamides (e.g., nylon), fluoropolymers (e.g., PTFE, PVF, or PVDF), and combinations thereof.

Where the collapsible tube is spirally wound, additional polymer or adhesive layers, if included, are situated between plies. Where the structure is a convolute tube, the additional polymer or adhesive layers, if included, are situated between layers of the rolled tube.

The collapsible tube may further include a bead between the first and second moisture-resistant and temperature-resistant layers. One or more beads or ridges may be formed by depositing cords of kraft paper between selected tube plies during tube formation. The beads may extend partly or fully across the length of the tube. Such beads help to reduce slippage and to retain the fiberglass filaments on the forming tubes during the winding process.

To prevent the glass fibers from tracking along the beads as they are wound around the tubes, it may be advantageous to lay down at least one bead in an irregular weave pattern. The beads are preferably formed from twisted kraft paper, but other materials known in the art may be used to form beads.

The collapsible tube may further include an intervening layer of fiberglass strands between the first and second moisture-resistant and temperature-resistant layers (e.g., between inner and outer metallic layers). The inclusion of fiberglass strands improves tube strength while maintaining the necessary flexibility. Such a fiberglass layer may include, for example, between about five and 15 strands of fiberglass.

The collapsible tube may further include a release coating on the second moisture-resistant and temperature-resistant layer (i.e., the outer protective layer). A release coating, such as a silicone release coating or a nylon release coating, can facilitate the removal of the tube from the interior windings of the glass fiber (i.e., the fiberglass spool).

It will be appreciated by those of ordinary skill in the art that, as used herein, the concept of one layer being “between” two other layers does not necessarily imply that the three layers are contiguous (i.e., in intimate contact). Rather, as used herein the concept of one layer being between two other layers is meant to describe the relative positions of the layers within the tube structure.

Additionally, the concept of one layer being “positioned on” another layer does not necessarily mean that the layers are contiguous (i.e., in intimate contact). Rather, as used herein, the concept of one layer being positioned on another layer is meant to describe the relative positions of the layers to one another.

In another embodiment, the collapsible tube is a paperboard structure (i.e., a paperboard form). This paperboard form is illustrated in FIG. 3 as a cylindrical tube 24. This depiction, however, is merely for illustration and should not be construed as limiting. The paperboard form may be cylindrical, conical, rectangular, or any other shape known in the art. As used herein, references to “tubes” refer to forms of any shape known in the art.

The paperboard structure may be spirally wound, convolute, or extruded. Preferably, the paperboard form is spirally wound. Spirally wound paperboard forms in accordance with the present invention preferably include one or more plies. Typically, the paperboard forms of the invention include between about one and ten plies.

Kraft paper, particularly kraft paper that possesses a basis weight of about 20 to 80 pounds, is a preferred paperboard. Those having ordinary skill in the art will recognize that basis weight reflects a 500-sheet ream of paper, each sheet being 24 inches by 36 inches. Various kinds of kraft paper can be used in the present invention, some examples being extensible paper, wet strength paper, and multi-walled paper. A preferred forming tube in accordance with the present invention has three or four plies made of 35-pound wet strength kraft paper. In other embodiments, different paperboard plies possess different basis weights.

The paperboard form has an inside surface 38 and an outside surface 40. An inner metal layer is preferably positioned upon the inside surface 38 of the paperboard structure 24 and an outer metal layer is preferably positioned upon the outside surface 40 of the paperboard structure 24.

The inner and outer metal layers may be spray coated or deposited via vapor deposition, but are preferably metal foil layers. Exemplary metal foil layers include, without limitation, aluminum foil, tin foil, stainless steel foil, and titanium foil, as well as combinations thereof. In this regard, the inner metal layer and the outer metal layer may be different kinds of foil. Metal foil layers are typically between about 0.0001 and 0.001 inch thick (i.e., 0.1-1.0 mil), and preferably less than about 0.005 inch thick (i.e., 5 mils).

In one variation, one or both metal foil layers are metal laminates of a paper layer and a metal layer. Such metal laminates may be spirally wound. Alternatively, such metal laminates may be affixed to an existing tube structure. Preferred metal laminates include a metal foil layer laminated to kraft paper layer, such as 15 to 25 pound kraft paper. Because the relatively thin metal foil is pre-bound to a relatively thicker paper layer, metal laminates can facilitate the manufacture of the forming tubes of the present invention.

Spirally wound inner and outer metal layers may independently form butt joints, overlap joints, or seam gap joints. Seam gap joints in the inner metal layer can help moisture and pressure to escape from the inner plies (i.e., those plies located between the inner metal layer and outer metal layer). Where seam gap joints are employed, the gaps are preferably between about 1/128 (i.e., about 8 mils) and 1/32 inch (i.e., about 32 mils). Overlap joints in the outer metal layers can help improve tube moisture resistance and smoothness.

In accordance with the prior description, the spirally wound paperboard form may include intervening polymer layers, adhesive layers, a fiberglass strands, and release coatings between the inner and outer metal layers.

The collapsible tubes of the present invention are typically between about six and 24 inches long, more typically between about 12 and 18 inches long, and between about three and 15 inches in diameter, more typically between about six and 12 inches in diameter. The collapsible tubes are generally between about 0.1 mm and 5 mm thick. Those having ordinary skill in the art will appreciate, of course, that the present invention is not limited to forming tubes of a particular size.

Spirally wound and convolute tubes according to the present invention may be formed in manufacturing lengths that are significantly greater than the cut-size lengths used in fiberglass processing. Stated otherwise, the collapsible tubes can be cut into desirable lengths after tube formation. Consequently, it may be prudent to seal any cut ends to retain the moisture and temperature resistance of the forming tube. In this regard, sealing cut ends may be achieved by laminating a metal foil layer over the tube ends or by dipping the tube ends into a suitable metallic solution.

In accordance with the foregoing, there are particularly useful forming tube embodiments.

In one embodiment, the forming tube is a substantially cylindrical fibrous structure in which a first metallic layer is positioned on the tube's inside surface and an independently selected second metallic layer is positioned on the tube's outside surface.

In another embodiment, the forming tube is a substantially cylindrical, collapsible paperboard structure in which an inner metal foil layer is positioned upon the tube's inside surface and an outer metal foil layer is positioned upon the tube's outside surface.

In yet another embodiment, the forming tube includes a plurality of spirally wound paperboard layers that form a substantially cylindrical, collapsible paperboard structure. The forming tube further includes an inner, spirally wound, metal foil layer that is laminated to the inside surface of the substantially cylindrical paperboard structure, and an outer, spirally wound, metal foil layer that is laminated to the outside surface of the substantially cylindrical paperboard structure.

In yet another embodiment, the forming tube is a substantially cylindrical, collapsible paperboard forming tube having excellent moisture and temperature resistance to facilitate its reuse. In this embodiment, the forming tube includes at least a first spirally wound paperboard laminate having an inner metal foil layer, which defines the forming tube's inner surface. The forming tube further includes a second spirally wound paperboard laminate having an outer metal foil layer, which defines the forming tube's outer surface.

In another embodiment, the forming tube includes an inner parchment paper layer and an outer parchment paper layer. An exemplary tube in accordance with this embodiment is collapsible and expandable to permit reuse.

In yet another embodiment, the forming tube includes an inner polymeric layer and an outer polymeric layer. An exemplary tube in accordance with this embodiment is collapsible and expandable to permit reuse. Additionally, an exemplary tube in accordance with this embodiment may be spirally wound, convolute, or extruded.

In another aspect, the ends of the moisture and temperature resistant forming tube are crimped (i.e., folded) to provide additional strength and moisture resistance. The ends may be folded over onto the forming tube's outer surface (i.e., crimped over) or folded under onto the forming tube's inner surface (i.e., crimped under). Alternatively, one end of the forming tube may be crimped over while the other end of the forming tube is crimped under.

Without being bound by theory, it is believed that the crimped ends provide additional moisture resistance by ensuring that the tube ends are also protected by the moisture and temperature resistant layers. Additionally, the crimped ends provide extra strength as a result of the added thickness at the end of the tube, rendering the forming tube more difficult to tear (e.g., less susceptible to rips while being moved onto or off of the collet). The added strength and moisture resistance increase the life of the collapsible forming tube, facilitating its repeated uses in the foregoing manufacturing processes.

Accordingly, in a related aspect, an otherwise conventional forming tube (e.g., a paperboard forming tube not incorporating the present moisture and temperature resistant layers) may be similarly crimped to improve whatever moisture and tear resistance it inherently possesses. In this regard, the forming tube's ends may be folded over onto its outer surface (i.e., crimped over), or folder under onto its inner surface (i.e., crimped under). Alternatively, one end of the tube may be crimped over while the other end of the tube is crimped under. For forming tubes having conventional designs, crimped ends especially provide tear resistance, thereby prolonging the tube's useable lifespan and making repeated uses more likely.

In yet another aspect, the moisture-resistant and temperature-resistant forming tube of the present invention may be perforated. Without being bound by theory, it is believed that the perforations enable easier transport of moisture and pressure through the body of the tube rather than only through the ends of the tube. In one embodiment, the perforations are clean (i.e., straight) perforations.

In another embodiment, the individual perforations may be folded onto the inside surface of the forming tube. The folded perforations would then have the moisture-resistant and temperature-resistant properties of the outer moisture-resistant and temperature-resistant layer of the forming tube. Accordingly, and without being bound by theory, it is believed that moisture intrusion into the sidewalls of the perforations, and therefore into the paperboard structure, would be prevented because the sidewalls of the perforations are lined with the outer moisture-resistant and temperature-resistant layer.

In the specification and drawings, there have been disclosed typical embodiments of the invention and, although specific terms have been employed, they have been used in a generic and descriptive sense only and not for purposes of limitation, the scope of the invention being set forth in the following claims.

1. A collapsible and expandable forming tube having excellent moisture and temperature resistance for use in the manufacture of glass fibers, said tube comprising:
a paperboard structure defining an inside surface and an outside surface;
a first moisture-resistant and temperature-resistant layer positioned on said inside surface of said paperboard structure;
a second moisture-resistant and temperature-resistant layer positioned on said outside surface of said paperboard structure;
wherein said first and second moisture-resistant and temperature-resistant layers include different material than said paperboard structure.

2. A collapsible and expandable forming tube according to claim 1, wherein said paperboard structure is substantially cylindrical.

3. A collapsible and expandable forming tube according to claim 1, wherein said paperboard structure comprises one or more spirally wound paperboard plies.

4. A collapsible and expandable forming tube according to claim 3, wherein said one or more spirally wound paperboard plies form overlap joints.

5. A collapsible and expandable forming tube according to claim 3, wherein said one or more spirally wound paperboard plies form butt joints.

6. A collapsible and expandable forming tube according to claim 3, wherein said one or more spirally wound paperboard plies form seam gap joints.

7. A collapsible and expandable forming tube according to claim 1, wherein said paperboard structure comprises a convolute tube.

8. A collapsible and expandable forming tube according to claim 1, further comprising an adhesive layer positioned between said first moisture-resistant and temperature-resistant layer and said second moisture-resistant and temperature-resistant layer.

9. A collapsible and expandable forming tube according to claim 1, wherein said first moisture-resistant and temperature-resistant layer is different than said second moisture-resistant and temperature-resistant layer.

10. A collapsible and expandable forming tube according to claim 1, wherein said tube is perforated.

11. A method of using the collapsible and expandable forming tube of claim 1, the method comprising:
(i) rotating the collapsible forming tube;
(ii) wrapping extruded fiberglass filaments around an outside surface of the forming tube to form a fiberglass spool;
(iii) thereafter drying the fiberglass spool at a temperature of at least about 250° F.;
(iv) thereafter deforming the tube and removing it from the fiberglass spool; and
(v) thereupon repeating steps (i)-(v).

12. A reusable forming tube having excellent moisture and temperature resistance, said tube comprising:
a substantially cylindrical structure defining an inside surface and an outside surface, said substantially cylindrical paperboard structure being collapsible to permit reuse;
an inner metal layer that is positioned on the inside surface of said substantially cylindrical paperboard structure; and
an outer metal layer that is positioned on the outside surface of said substantially cylindrical paperboard structure.

13. A reusable forming tube according to claim 12, wherein said inner metal layer and said outer metal layer are independently selected from one or more of metallic spray, metallic deposition material, and combinations thereof.

14. A reusable forming tube according to claim 5, wherein at least one of said inner metal layer and said outer metal layer comprise a metal foil layer.

15. A reusable forming tube according to claim 14, wherein at least one of said inner metal layer and said outer metal layer comprises a metal foil layer selected from the group consisting of aluminum foil, tin foil, stainless steel foil, titanium foil, and combinations thereof.

16. A reusable forming tube according to claim 14, wherein at least one of said inner metal layer and said outer metal layer comprise a paperboard laminate including a metal foil layer.

17. A reusable forming tube according to claim 12 wherein at least one of said inner metal layer and said outer metal layer is spirally wound.

18. A reusable forming tube according to claim 12, further comprising a bead positioned between said inner metal layer and said outer metal layer.

19. A method of using the reusable forming tube of claim 12, the method comprising:
(i) rotating the paperboard tube;
(ii) wrapping extruded fiberglass filaments around an outside surface of the forming tube to form a fiberglass spool;
(iii) thereafter heating the fiberglass spool at a temperature of at least about 250° F. for a time sufficient for the fiberglass filaments to dry;
(iv) thereafter deforming the tube and removing it from the fiberglass spool; and
(v) thereupon repeating steps (i)-(v).

20. A substantially cylindrical forming tube having excellent moisture and temperature resistance, said tube comprising:
an inner parchment paper layer; and
an outer parchment paper layer; and
wherein said forming tube is collapsible and expandable to permit reuse.

21. A substantially cylindrical forming tube according to claim 20, further comprising a fibrous structure between said inner parchment paper layer and said outer parchment paper layer.

22. A substantially cylindrical forming tube according to claim 20, wherein at least one of said inner parchment paper layer and said outer parchment paper layer are spirally wound.

23. A substantially cylindrical forming tube according to claim 20, wherein said forming tube is a convolute tube.

24. A substantially cylindrical forming tube according to claim 20, further comprising a bead between said inner parchment paper layer and said outer parchment paper layer.

25. A substantially cylindrical forming tube according to claim 20, further comprising a release coating on said outer parchment paper layer.

26. A method of using the substantially cylindrical forming tube of claim 20, the method comprising:
(i) rotating the substantially cylindrical, collapsible tube;
(ii) wrapping extruded fiberglass filaments around an outside surface of the forming tube to form a fiberglass spool;
(iii) thereafter heating the fiberglass spool at a temperature of at least about 250° F. for a time sufficient for the fiberglass filaments to dry;
(iv) thereafter deforming the tube and removing it from the fiberglass spool; and
(v) thereupon repeating steps (i)-(v).

27. A substantially cylindrical forming tube having excellent moisture and temperature resistance, said tube comprising:
an inner polymer layer; and
an outer polymer layer; and
wherein said forming tube is collapsible and expandable to permit reuse.

28. A substantially cylindrical, collapsible forming tube according to claim 27, wherein said forming tube is an extruded forming tube.

29. A substantially cylindrical, collapsible forming tube according to claim 27, further comprising a fibrous structure between said inner polymer layer and said outer polymer layer.

30. A substantially cylindrical, collapsible forming tube according to claim 29, wherein at least one of said inner polymer layer and said outer polymer layer is spirally wound.

31. A substantially cylindrical, collapsible forming tube according to claim 27, further comprising a bead between said inner polymer layer and said outer layer.

32. A substantially cylindrical, collapsible forming tube according to claim 27, wherein said inner polymer layer and said outer polymer layer are independently selected from one or more of polyolefins, polyamides, fluoropolymers, and combinations thereof.

33. A substantially cylindrical, collapsible forming tube according to claim 27, further comprising at least one adhesive layer between said inner polymer layer and said outer polymer layer.

34. A method of using the substantially cylindrical, collapsible forming tube of claim 27, the method comprising:
(i) rotating the substantially cylindrical, collapsible tube;
(ii) wrapping extruded fiberglass filaments around an outside surface of the forming tube to form a fiberglass spool;
(iii) thereafter heating the fiberglass spool at a temperature of at least about 250° F. for a time sufficient for the fiberglass filaments to dry;
(iv) thereafter deforming the tube and removing it from the fiberglass spool; and
(v) thereupon repeating steps (i)-(v).
